(19) United States
(12) Patent Application Publication
(10) Pub. No.: US 2003/0155393 A1
(43) Pub. Date: Aug. 21, 2003

(54) Memo device

(76) Inventor: Deborah Tucker, Kingston, NY (US)

Correspondence Address: JOHN MAIER, III, 666 AARON COURT, KINGSTON, NY, 12401, US

(21) Appl. No.: 10/080,947

(22) Filed: Feb. 21, 2002

(51) Int. Cl. B26F 3/02

(52) U.S. Cl. 225/39; 225/88

(57) ABSTRACT

A memo device utilizing a roll of paper that can be fed in opposite directions so that whether the device is used in a horizontal position or in a vertical position, writing can be commenced at the top of the paper adjacent to the open end so that the length of the writing can extend beyond the length of the paper originally extended from the paper roll.

### FIELD OF THE INVENTION

This invention relates to memo devices and more particularly to a memo device which permits notes to be written on a roll of paper commencing at the end of a roll of paper with the dispenser either being on a table top or mounted on a wall so that the length of the notes is limited only by the paper available in the paper roll.

### PRIOR ART

In the Urquhart, et. al. Patent, U.S. Pat. No. 3,645,595, a drawing device is taught utilizing paper dispensed from a roll. Instinctively, writing is commenced at the top of the paper. With the paper being fed, as taught by Urquhart, et. al., should the notation not be complete by the time the writing reaches the bottom of the original page, further writing will have to be continued above the beginning point.

The Lane Patent, U.S. Pat. No. 5,432,687 teaches a writing paper rmemo system which feeds the paper in an upwardly direction. As a result, with the Lane device, starting at the top of the paper where the open end is located, the paper can be continuously fed, as long as paper is available from the paper roll, thereby permitting a continuous written document. However, this advantage is only possible with the device taught by Lane when the device is placed upon a flat surface and not when the device is hung in a vertical position.

The Scholfield Patent, U.S. Pat. No. 5,549,232, teaches a device for feeding memo paper from a roll that can be used in both a horizontal position and a vertical position. However, in both the vertical position and the horizontal position, the paper is fed so that the top of the paper is remote from the open end of the paper roll.

### OBJECTS

Since some people find mounting a memo device vertically to be most convenient while others prefer using the memo device on a horizontal surface, it is advantageous to produce a memo device that can be readily used in both a vertical position and a horizontal position while being able, regardless of the position of mounting, always to be able to commence writing both at the top of the sheet as well as at the open end of the paper from the paper roll.

Accordingly, it is an object of the present invention to provide a memo device utilizing paper from a paper roll that can be mounted in both a vertical position and in a horizontal position.

It is a further object of this invention to produce a memo device that permits writing to commence both at the top of the paper and at the open end of the paper roll regardless of whether the memo device is mounted in a vertical position or in horizontal position.

It is still another object of this invention to produce a memo device utilizing paper from a paper roll which is both inexpensive and durable.

Further objects and advantages of the invention will be apparent from the description below.

### SUMMARY OF THE INVENTION

A memo device is provided which may be mounted either vertically or horizontally for making notations on a paper sheet fed from a paper roll which permits starting notations both at the top of the paper sheet and the open end of the roll. A writing panel is mounted on a narrow end panel and a wide end panel. Both the wide end panel and the narrow end panel has a slot through it. A narrow end bar is mounted across the writing panel slightly above the writing panel which has a cutting edge adjacent to the narrow end panel. A wide end bar is mounted across the writing panel slightly above the writing panel and the wide end bar has a cutting edge adjacent to the wide end panel. Means are also provided for mounting the paper roll.

### DETAILED DESCRIPTION OF THE DRAWINGS

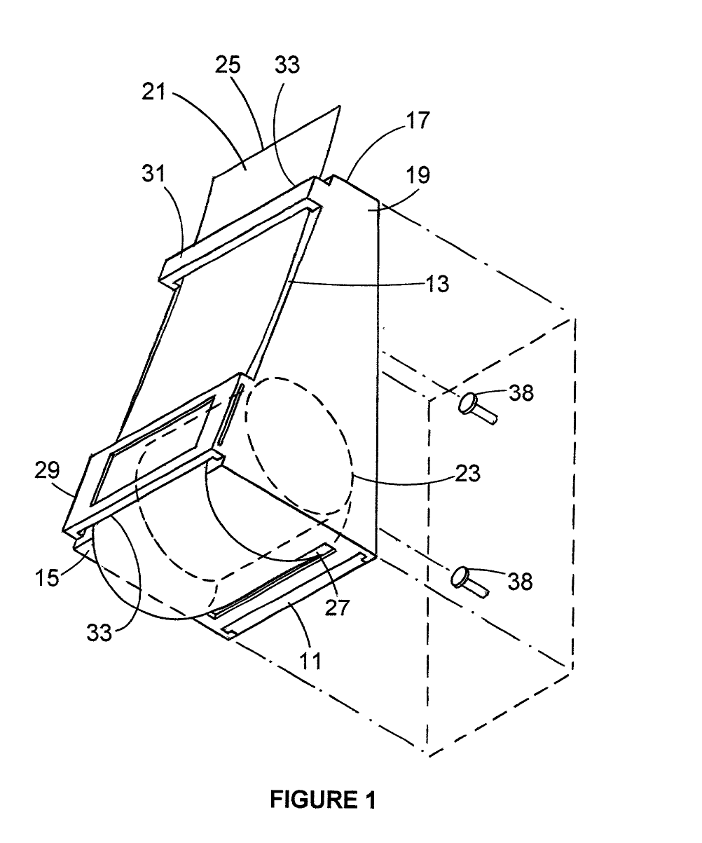

FIG. 1 is a pictorial view of the memo device mounted in a vertical position with the memo device withdrawn from the vertical support and with the mounted surface shown in broken lines and with the paper roll and the path of paper shown by broken lines within the device.

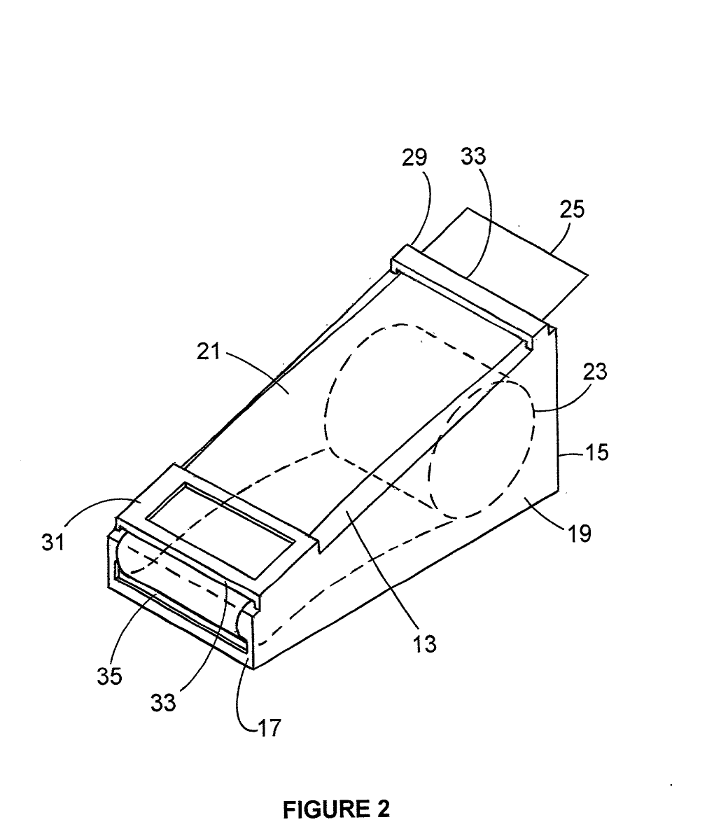

FIG. 2 is a pictorial view of the memo device shown in the horizontal position and with the paper roll and the path of the paper shown in broken lines.

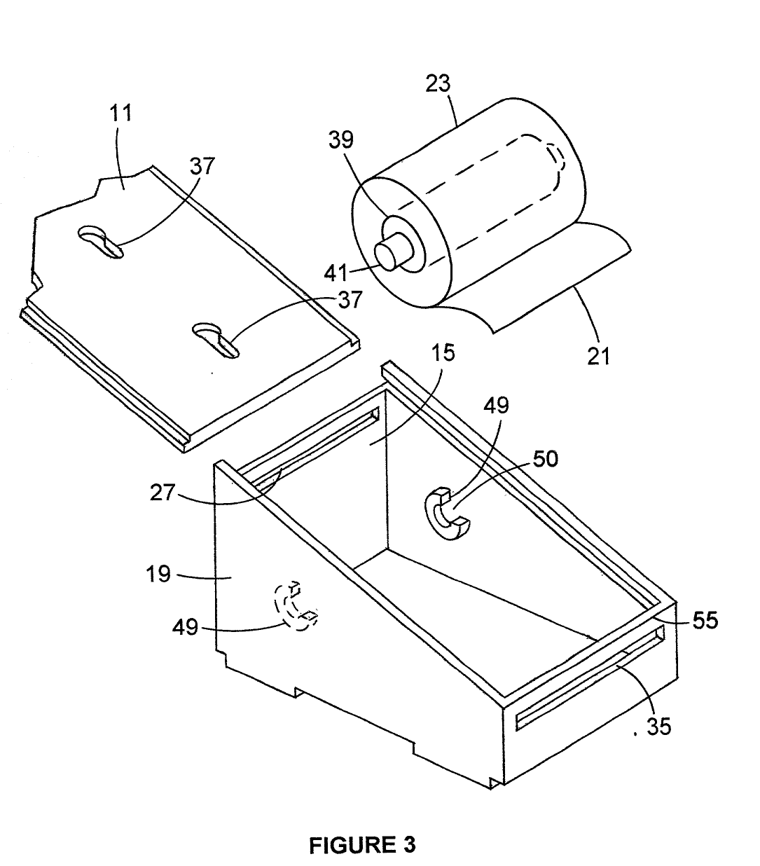

FIG. 3 is a pictorial view of the memo device upside down showing the removable base panel.

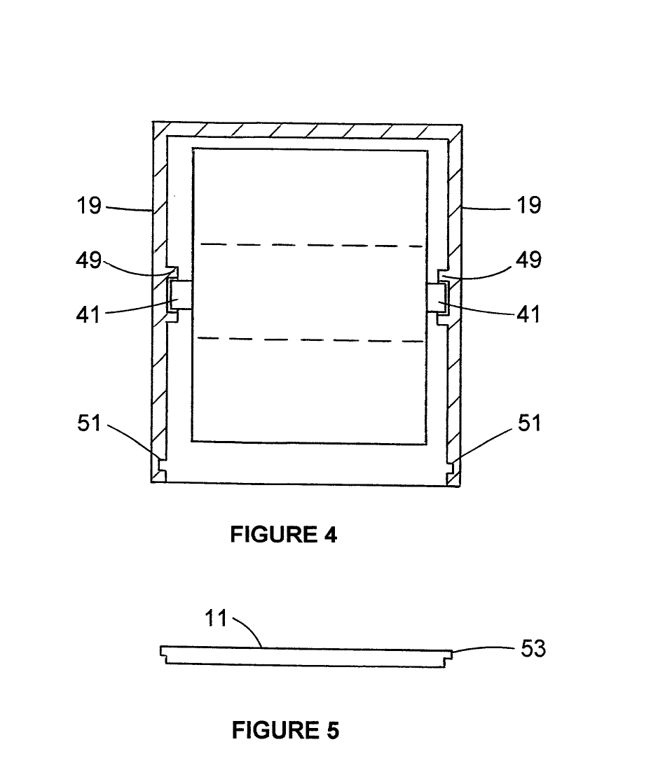

FIG. 4 is a cross sectional view of the spindle and the side panels.

FIG. 5 is a cross sectional view of the base panel.

### DETAILED DESCRIPTION OF THE NUMERALS

NUMERAL DESCRIPTION

11 Base Panel

13 Writing Panel

15 Wide End Panel

17 Narrow End Panel

19 Side Panels

21 Paper

23 Paper Roll

25 Open End (paper)

27 Slot (wide end panel)

29 Wide End Bar

31 Narrow End Bar

33 Cutting Edge

35 Slot (narrow end panel)

37 Openings

38 Nail

39 Spindle

41 Mounting Pins

49 Journals

50 Openings (Journals)

51 Interior Groove

53 Tongues

55 Stop Bar

### DETAILED DESCRIPTION OF THE PREFERRED EMBODIMENT

Referring now to FIG. 1 and FIG. 2, a comparison is shown of the path of the paper from a paper roll when the memo device is used in a vertical position, such as when it is mounted on a wall as shown in FIG. 1 and when it is placed in a horizontal position, such as when it is placed on a desk as shown in FIG. 2.

The memo device has a base panel 11 and a writing panel 13. The writing panel 13 is at an incline to the base panel 11. A wide end panel 15 is located where the distance between the base panel 11 and the writing panel 13 is the greatest, and a narrow end panel 17 is located where the writing panel 13 and the base panel 11 are closest to one another. Two side panels 19 are located between the writing panel 13 and the base panel 11 and between the narrow end panel 17 and the wide end panel 15.

Paper 21 from a paper roll 23 is fed across the writing panel 13. At the most remote point of the paper 21 from the paper roll 23 is the open end 25 of the paper 21. When writing on the memo device, the writing could become extensive causing the need for more paper 21 than initially available on the writing panel 13. It is also instinctive to start writing at the top of the paper 21. By starting whatever writing is desired, such as a list of items, at the open end 25 of the paper 21, the writing can continue virtually indefinitely, being limited only by the quantity of paper 21 available on the paper roll 23.

As can best be seen in FIG. 1, with the memo device mounted in a vertical position, and the open end 25 of the paper 21 at the top of the writing panel 13, the narrow end panel 17 of the memo device is also at the top of the memo device. The wide end panel 15, as a result, is at the bottom of the memo device. The paper 21 is fed off the paper roll 23 through a slot 27 in the wide end panel 15 adjacent to the base panel 11. The paper 21 feeds over the wide end panel 15 and across the writing panel 13. Slightly above the writing panel 13, adjacent to the wide end panel 15 is a wide end bar 29 mounted slightly over the writing panel 13 so that the paper 21 is fed beneath it. Similarly, adjacent to the narrow end panel 17 and slightly above the writing panel 13 is a narrow end bar 31. Both the wide end bar 29 and the narrow end bar 31 are supported at their ends on the side panels 19.

The wide end bar 29 and the narrow end bar 31 each have a cutting edge 33. The cutting edge 33 for the wide end bar 29 is located closest to the wide end panel 15 while the cutting edge 33 for the narrow end bar 31 is located closest to the narrow end panel 17. The wide end bar 29 and the narrow end bar 31 are both suitable for displaying advertisements.

Referring to FIG. 1, with the memo device being vertically mounted, the paper 21 would be pulled upwardly and then pulled back against the narrow end bar 31 to be cut off at the desired point, most likely at the conclusion of the writing on the paper 21 by the cutting edge 33 of the narrow end bar 31.

Referring now to FIG. 2, the memo device is shown in the horizontal position such as when placed on a desk or table. Once again, the paper 21 is fed so that the open end 25 is at the top of the writing panel 13. To achieve this, the paper 21 is fed from the paper roll 23 inside the memo device across the base panel 11. A slot 35 is located in the narrow end panel adjacent to the base panel 11. The paper 21 is fed through the slot 35 in the narrow end panel 17 and over the narrow end panel 17 and under narrow end bar 31. The paper 21 continues across the writing panel 13 and under the wide end bar 29. The paper 21, once pulled out, is cut off by pulling against the cutting edge 33 of the wide end bar 29.

By comparing FIG. 1 and FIG. 2, it is clear that the paper roll 23 rotates in opposite directions and is fed to opposite ends of the memo device when hung vertically and when placed on a generally horizontal surface.

In order to place the memo device on a generally vertical surface, such as a wall, as shown in FIG. 5, openings 37 to receive a nail head 38 or other wall fastener, are located in the base panel 11. The openings 37 are located along the centerline of the base panel 11 with one opening 37 located toward the narrow end panel 17 and another opening 37 located toward the wide end panel 15.

The paper roll 23 is mounted within the memo device adjacent to the wide end panel 15. In this way, the paper roll 23 can have a maximum diameter to provide the greatest supply of paper 21. The paper roll 23 is mounted on a spindle 39, shown in FIG. 6. The spindle 39 has two mounting pins 41.

As seen in FIG. 4, journals 49 are mounted so as to oppose one another on the inside of the side panels 19 and the mounting pins 41 are placed into the journals with the paper roll 23 on the spindle 39 but with the rotation of the paper roll 23 selected for the position in which the memo device will be used. The journals 49 have openings 50 to permit the mounting pins 41 to be forced into the journals 49.

In order to replenish the paper roll 23 or to revise direction of rotation, access must be provided into the memo device. The base panel 11 is therefore removable. As best shown in FIG. 3, FIG. 4 and FIG. 5, the side panels 19, along the base panel 11, have a pair of grooves 51. The base panel 11 has a pair of tongues 53, as shown in FIG. 8, which matches the grooves 51 in the side panels 19 shown in FIG. 5. This permits the base panel 11 to slide onto the side panels 19. However, so as to prevent the memo device from sliding off the base panel 11 when the Memo Device is mounted in a vertical position, a stop bar 55 is located between the side panels 19 adjacent to the narrow end panel 17.

Various additions can be made to the memo device. For example, clips (not shown) may be mounted on both side panels 19 to hold a writing pen or pencil (not shown).

It is to be understood that the drawings and description matter are in all cases to be interpreted as merely illustrative of the principles of the invention, rather than as limiting the same in any way, since it is contemplated that various changes may be made in various elements to achieve like results without departing from the spirit of the invention or the scope of the appended claims.

The claims are:

1. A memo device which may be mounted either vertically or horizontally for making notations on a paper sheet fed from a paper roll which permits starting notations both at the top of the paper sheet and the open end of the roll, said memo device comprising:
a writing panel;
a narrow end panel having a slot through it;
a wide end panel having a slot through it, the writing panel being mounted on the narrow end panel and the wide end panel;
a narrow end bar mounted across the writing panel slightly above the writing panel, the narrow end bar having a cutting edge adjacent to the narrow end;
a wide end bar mounted across the writing panel slightly above the writing panel, the wide end bar having a cutting edge adjacent to the wide end; and
means for mounting the paper roll adjacent to the wide end panel and beneath the writing panel.

2. A memo device according to claim 1 wherein the narrow end panel and the wide end panel are substantially parallel to one another.

3. A memo device according to claim 1 wherein the means for mounting the paper roll includes a pair of opposing journals and a spindle mounted in the journals.

4. A memo device which may be mounted either vertically or horizontally for making notations on a paper sheet fed from a paper roll which permits starting notations both at the top of the paper sheet and the open end of the roll, said memo device comprising:
two side panels, each side panel having a narrow end edge and a wide end edge, the wide end edges being larger than the narrow end edges;
a writing panel mounted on the two side panels along the writing edges;
a narrow end panel mounted between the two side panels along the narrow edges, the narrow end panel having a slot through it;
a wide end panel mounted between the two side panels along the wide edges, the side end panel having a slot through it;
a narrow end bar mounted across the writing panel slightly above the writing panel, the narrow end bar having a cutting edge adjacent to the narrow end;
a wide end bar mounted across the writing panel slightly above the writing panel, the wide end bar having a cutting edge adjacent to the wide end; and
means for mounting the paper roll between the side panels.

5. A memo device according to claim 4 wherein the two side panels each has a base edge, each writing edge being inclined to a base edge.

6. A memo device according to claim 4 wherein the two side panels each has a base edge, each writing edge being inclined to a base edge; and
a base panel mounted on the side panels along the base edge.

7. A memo device according to claim 4 wherein the side panels are substantially parallel to one another.

8. A memo device according to claim 4 wherein the narrow end panel and the wide end panel are substantially parallel to one another.

9. A memo device according to claim 4 wherein the narrow end panel and the wideend panel are substantially parallel to one another and are substantially at right angles to the side panels

10. A memo device according to claim 4 wherein the means for mounting the paper roll between the side panels includes pair of opposing journals mounted on the side panels and a spindle mounted in the journals.

11. A memo device which may be mounted either vertically or horizontally for making notations on a paper sheet fed from a paper roll which permits starting notations both at the top of the paper sheet and the open end of the roll, said memo device comprising:
two side panels, each side panel having a base edge, a writing edge, a narrow end edge and a wide end edge, the wide end edges being larger than the narrow end edges, the writing edges being inclined to the base edges;
a base panel mounted on the two side panels along the base edge;
a writing panel mounted on the two side panels opposite from the base panel and at an angle to the base panel along the writing edges;
a narrow end panel mounted between the base panel and the writing panel and between the two side panels along the narrow edges, the narrow end panel having a slot through it adjacent to the base panel;
a wide end panel mounted between the base panel and the writing panel and between the two side panels along the wide edges, the side end panel having a slot through it adjacent to the base panel;
a narrow end bar mounted across the writing panel slightly above the writing panel, the narrow end bar having a cutting edge adjacent to the narrow end;
a wide end bar mounted across the writing panel slightly above the writing panel, the wide end bar having a cutting edge adjacent to the wide end; and
a spindle mounted in the journals.

12. A memo device according to claim 11 wherein the side panels are substantially parallel to one another.

13. A memo device according to claim 11 wherein the narrow end panel and the wide end panel are substantially parallel to one another.

14. A memo device according to claim 11 wherein the narrow end panel and the wide end panel are substantially parallel to one another and are substantially at right angles to the side panels.

15. A memo device according to claim 11 wherein the means for mounting the paper roll between the side panels includes a pair of opposing journals mounted on the side panels and a spindle mounted in the journals.

16. A memo device which may be mounted either vertically or horizontally for making notations on a paper sheet fed from a paper roll which permits starting notations both at the top of the paper sheet and the open end of the roll, said memo device comprising:
two side panels, each side panel having a base edge, a writing edge, a narrow end edge and a wide end edge, the narrow end edge and the wide end edge being substantially parallel to one another and generally being at right angles to the base edges, the wide end edges being larger than the narrow end edges, the writing edges being inclined to the base edges, the side panels being substantially parallel to one another and having opposing journals located toward the wide end edges and between the writing edges and the base edges;
a base panel mounted on the two side panels along the base edges;
a writing panel mounted on the two side panels opposite from the base panel and at an angle to the base panel along the writing edges;
a narrow end panel mounted between the base panel and the writing panel and between the two side panels along the narrow edges, the narrow end panel having a slot through it adjacent the base panel;
a wide end panel mounted between the base panel and the writing panel and between the two side panels along the wide edges, the side end panel having a slot through it adjacent the base panel, the narrow end panel and the wide end panel being substantially to one another and being generally at right angles to the side panels;
a narrow end bar mounted on the side panels and across the writing panel slightly above the writing panel, the narrow end bar having a cutting edge adjacent the narrow end;
a wide end bar mounted on the side panels and across the writing panel slightly above the writing panel, the wide end bar having a cutting edge adjacent the wide end; and
a spindle having a mounting pin at each end, one of the mounting pins being spring loaded, the mounting pins being mounted in the journals.

17. A memo device according to claim 16 wherein the base panel is slidably mounted on the two side panels.
